(19) United States
(12) Patent Application Publication
(10) Pub. No.: US 2016/0049966 A1
(43) Pub. Date: Feb. 18, 2016

(54) RFIC ARCHITECTURE FOR MULTI-STREAM REMOTE RADIO HEAD APPLICATION

(71) Applicant: Aviacomm Inc., Sunnyvale, CA (US)

(72) Inventors: Hans Wang, Mountain View, CA (US); Tao Li, Campbell, CA (US); Binglei Zhang, San Jose, CA (US); Shih Hsiung Mo, San Jose, CA (US)

(73) Assignee: Aviacomm Inc., Sunnyvale, CA (US)

(21) Appl. No.: 14/791,384

(22) Filed: Jul. 3, 2015

Related U.S. Application Data
(60) Provisional application No. 62/038,013, filed on Aug. 15, 2014.

(51) Int. Cl. H04B 1/00; H04L 25/02; H04L 27/00

(52) U.S. Cl. CPC H04B 1/0064; H04L 27/0002; H04L 25/02; H04B 2001/0408

(57) ABSTRACT

One embodiment of the present invention provides a remote radio head (RRH) for a wireless communication system. The RRH includes a first integrated circuit (IC) chip that comprises multiple functional blocks and a second IC chip that comprises at least an up-converter and a down-converter. The multiple functional blocks include at least a processing unit, a digital-to-analog converter (DAC), and an analog-to-digital converter (ADC). The up-converter is configured to convert an intermediate frequency (IF) signal received from the first IC chip to the radio frequency (RF) domain, and the down-converter is configured to convert an RF signal received from an antenna to an IF signal to be sent to the first IC chip.

### RELATED APPLICATION

This application claims the benefit of U.S. Provisional Application No. 62/038,013, Attorney Docket Number AVC14-1007PSP, entitled “RFIC Architecture Suitable for LTE/WCDMA Remote Radio Head (RRH) Application,” by inventors Hans Wang, Tao Li, Binglei Zhang, and Shih Hsiung Mo, filed 15 Aug. 2014.

### BACKGROUND

1. Field

The present disclosure relates generally to a radio frequency integrated circuit (RFIC) chip. More specifically, the present disclosure relates to an RFIC architecture that is suitable to be used in a remote radio head (RRH) that provides signals for multiple antennas or multiple services.

2. Related Art

Remote radio head (RRH) plays an important role in wireless communication systems. RRH equipment is used to extend the coverage of a base station to regions like rural areas or tunnels. In practice, RRH equipment is connected to the base station via a fiber optic cable using Common Public Radio Interface (CPRI) protocol.

A typical RRH includes the base station's radio frequency (RF) circuitry, such as the RF transceiver and RF front end, digital-to-analog converter (DAC), analog-to-digital converter (ADC), optical transceiver for interfacing with the base station, and a field-programmable gate array (FPGA) handling the CPRI. When deployed, the RRHs are often installed at outdoor locations close to the antenna, such as at the top of the cell tower. Among many requirements, low unit cost, a small form factor, and low power consumption are key design requirements for RRH systems.

### SUMMARY

One embodiment of the present invention provides a remote radio head (RRH) for a wireless communication system. The RRH includes a first integrated circuit (IC) chip that comprises multiple functional blocks and a second IC chip that comprises at least an up-converter and a down-converter. The multiple functional blocks include at least a processing unit, a digital-to-analog converter (DAC), and an analog-to-digital converter (ADC). The up-converter is configured to convert an intermediate frequency (IF) signal received from the first IC chip to the radio frequency (RF) domain, and the down-converter is configured to convert an RF signal received from an antenna to an IF signal to be sent to the first IC chip.

In a variation on this embodiment, the RRH further includes a plurality of RF front-end components that are packaged into a system in package (SiP) module.

In a variation on this embodiment, the processing unit is configured to facilitate a communication interface between a base station and the RRH, and the communication interface includes one of: a common public radio interface (CPRI) and an open base station architecture initiative (OBSAI) interface.

In a variation on this embodiment, the processing unit is configured to: receive an in-phase (I) baseband data stream and a corresponding quadrature (Q) baseband data stream from a base station, and digitally modulate the I baseband data stream and the Q baseband data stream to a real IF data stream, thereby allowing the real IF data stream to be converted to the analog domain using a single DAC channel.

In a further variation, the second IC chip further comprises one or more amplifiers, and the amplifiers have a gain bandwidth that is at least twice the baseband data streams' bandwidth.

In a further variation, the gain bandwidth is at least 40 MHz.

In a variation on this embodiment, the ADC is configured to convert the down-converted IF signal to a digital IF signal using a single channel and the processing unit is configured to demodulate the digital IF signal to an in-phase (I) data stream and a quadrature data stream.

One embodiment of the present invention provides a system for transmitting data for wireless communication using a remote radio head (RRH). During operation, the system receives, by the RRH from a base station, baseband data that includes an in-phase data stream and a quadrature (Q) data stream; digitally modulates the I data stream and the Q data stream into a real intermediate frequency (IF) data stream; converts the real IF data stream to an analog IF signal; frequency up-converts the analog IF signal to an analog RF signal; and transmits the converted RF signal.

One embodiment of the present invention provides a system for receiving data for wireless communication using a remote radio head (RRH). During operation, the system receives, by the RRH from an antenna, a radio frequency (RF) signal; frequency down-converts the RF signal to an intermediate frequency (IF) signal; converts the IF signal to a digital IF data stream; digitally demodulates the IF data stream to an in-phase (I) baseband data stream and a quadrature (Q) baseband data stream; and sends the I and Q baseband data streams to a base station.

One embodiment of the present invention provides a radio frequency integrated circuit (RFIC) chip implemented in a remote radio head (RRH). The RFIC chip is configured to communicate with a base station via a second IC chip. The RFIC chip includes at least an up-converter and a down-converter. The up-converter is configured to convert an intermediate frequency (IF) signal received from the second IC chip to the radio frequency (RF) domain, and the down-converter is configured to convert an RF signal received from an antenna to an IF signal to be sent to the second IC chip.

In a variation on this embodiment, the RFIC chip further includes multiple signal paths to allow multiple IF signals to be up-converted to the RF domain and multiple RF signals to be down-converted to the IF domain simultaneously.

### BRIEF DESCRIPTION OF THE FIGURES

FIG. 1 presents a diagram illustrating the architecture of a wireless network that implements remote radio head.

FIG. 2 presents a diagram illustrating the architecture of a conventional single channel RRH (prior art).

FIG. 3 presents a diagram illustrating the exemplary architecture of a multi-stream RRH, in accordance with an embodiment of the present invention.

FIG. 4 presents a diagram illustrating the exemplary architecture of an SoC module implemented in a multi-stream RRH, in accordance with an embodiment of the present invention.

FIG. 5 presents a diagram illustrating the exemplary architecture of an RFIC module, in accordance with an embodiment of the present invention.

FIG. 6 presents a diagram illustrating an exemplary architecture of a low-IF RFIC, in accordance with an embodiment of the present invention.

FIG. 7 presents a diagram illustrating the exemplary architecture of the RRH in the RX direction, in accordance with an embodiment of the present invention.

FIG. 8A presents a diagram illustrating the spectrum of the RF signals at the input of each receiving path of the RFIC, in accordance with an embodiment of the present invention.

FIG. 8B presents a diagram illustrating the spectrum of the IF signals at the output of each receiving path of the RFIC, in accordance with an embodiment of the present invention.

FIG. 9 presents a diagram illustrating the exemplary architecture of the RRH in the TX direction, in accordance with an embodiment of the present invention.

FIG. 10A presents a diagram illustrating the spectrum of the signal at the DAC output, in accordance with an embodiment of the present invention.

FIG. 10B presents a diagram illustrating the spectrum of the signal at the output of the each BPF, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide an RFIC architecture for the application of a multi-stream remote radio head (RRH). The proposed RFIC architecture includes frequency converters that convert RF signals to low intermediate frequency (IF) signals. More specifically, in the transmitting (TX) direction, this low-IF RFIC architecture allows the I and Q channels of quadrature-modulated baseband signals to be combined as real IF signals before being sent to digital-to-analog converters (DACs) for DA conversion, thus reducing the needed DAC channels by half. In the receiving (RX) direction, the RF signals are first converted to low-IF signals, and then sent to the analog-to-digital converters (ADCs) for AD conversion. In additional to the reduced number of AD/DA channels, which leads to smaller device size and lower power consumption, the low-IF RFIC architecture also relaxes the calibration requirements for DC offset and IQ imbalance, thus lowering the maintenance costs for the RRH.

### Multi-Stream Remote Radio Head

RRH has become a key component in modern-day wireless networks, such as the long-term evolution (LTE) and wideband code division multiple access (WCDMA) networks. The deployment of RRHs can reduce the carrier's requirement for site resources and investment while improving the effect of coverage. Moreover, placing RRHs at locations close to the antenna reduces feeder line loss. RRH can also support the need for coverage at special locations, such as along high-speed railways.

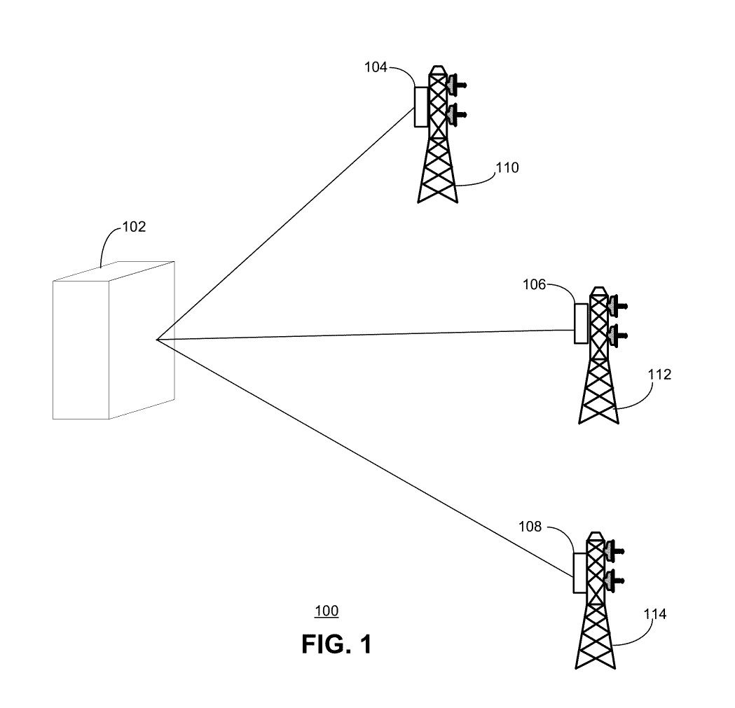

FIG. 1 presents a diagram illustrating the architecture of a wireless network that implements remote radio head. In FIG. 1, wireless network 100 includes a base station 102 and a number of towers, such as towers 110, 112, and 114. Note that base station 102 may only include basic baseband processing modules, such as a digital signal processor (DSP), and the control circuitry. Other RF front-end functionalities are handled by RRHs. Each tower can be equipped with one or more RRHs that are coupled to the one or more antennas located on the tower. For example, tower 110 includes an RRH 104, tower 112 includes an RRH 106, and tower 114 includes an RRH 108. A typical RRH can include standard RF front-end components, such as ADCs/DACs, modulators/demodulators, amplifiers, filters, switches, etc. In addition, the RRH often includes an optical interface for communicating with the base station. A high level of integration, low power loss, and small size are key design requirements for RRHs. Such requirements can be a challenge, especially in long-term evolution (LTE) wireless networks that implement multi-input multi-output (MIMO) technology.

In LTE networks, there are various MIMO implementations, such as: receive diversity (a single data stream is transmitted on one antenna and received by multiple antennas), transmit diversity (a single data stream is transmitted over multiple antennas), spatial multiplexing (multiple data streams are transmitted over multiple antennas), multi-user MIMO (MU-MIMO), and beam-forming (using antenna arrays to focus transmission to a particular area). Among the various MIMO implementations, the beam-forming scheme is the most complex. However, by enabling the antenna to focus on a particular area, this MIMO implementation reduces interference and increases capacity, because a particular user equipment (UE) will have a beam formed in its particular direction. To implement MIMO in the beam-forming mode, an RRH needs to provide multiple correlated data streams (which may occupy the same frequency band) to the multiple antennas. Therefore, a single RRH device may need to handle the multiple correlated data streams. In other words, the RRH device needs to have more than one channel. For example, to implement 2×2 or 4×4 MIMO, a single RRH device needs to have a capacity of four or eight channels (considering each quadrature-modulated data stream may need two signal paths).

In addition to supporting the multiple antennas, an RRH may also need to support multiple services by transmitting/receiving signals for multiple different carriers or signals of the same carrier but occupying multiple frequency bands. In such scenarios, the RRH may need to provide multiple un-correlated data streams (often occupying different frequency bands) to a single antenna. Similarly, to enable the multi-service transmission/receiving, an RRH needs to have a multi-stream capacity.

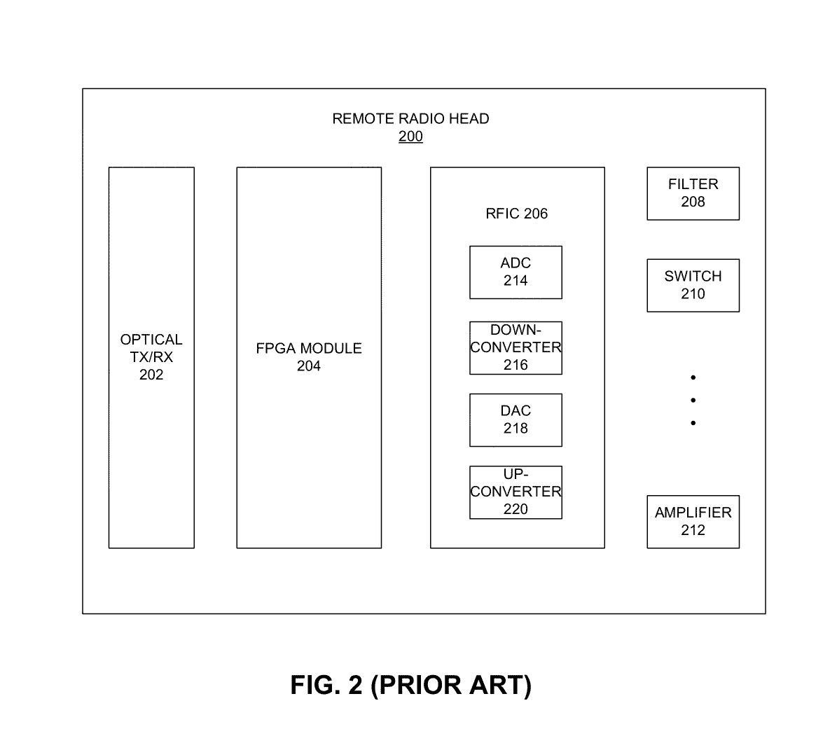

FIG. 2 presents a diagram illustrating the architecture of a conventional single channel RRH (prior art). In FIG. 2, an RRH 200 includes an optical transceiver 202, an FPGA module 204, an RFIC module 206, and a number of RF front-end components, such as a filter 208, a switch 210, an amplifier 212, etc.

Optical transceiver 202 interfaces with the base station via optical fibers, and transmits/receives baseband digital signals. FPGA module 204 typically includes a standard CPRI interface. Note that the CPRI interface is a standardized interface between the radio equipment control (REC) and the radio equipment (RE) in wireless base stations, thus allowing interoperability of equipment from different vendors, while preserving the software investment made by wireless service providers. In cases of RRH, the REC remains at the base station, and the RE is the RRH. In addition to the CPRI interface, FPGA module 204 also includes certain processing capabilities that can process operation and maintenance signals originated from the base station.

RFIC module 206 includes a number of RF components that are integrated onto a single IC chip. In conventional systems, RFIC module 206 typically handles the conversion between digital and analog signals, and the frequency conversion between the baseband and the RF signals. To do so, a typical RFIC module 206 may include an ADC 214, a down-converter 216, a DAC 218, and an up-converter 220. ADC 214 and down-converter 216 are part of the receiving path, and DAC 218 and up-converter 220 are part of the transmission path. Note that for quadrature-modulated signals, each receiving (or transmission) path actually requires dual-channel ADC (or the DAC) to handle both the in-phase (I) and the quadrature (Q) signals, especially in the case of direction conversions where the RF signals are directly converted to baseband.

From FIG. 2, one can see that it can be very challenging to increase the capacity of the conventional RRH because doubling the RRH channel count means that the number of components, such as ADCs, DACs, or the RF front-end components, also needs to be doubled. This can be particularly problematic in the case of direct conversion because the number of ADCs/DACs or the number of channels in the ADC/DAC needs to be at least twice the number of RRH channels. For example, two IQ-modulated RRH data streams will need up to four DACs or DAC channels to separately convert the I and Q channels to the analog domain. This can lead to increased size and power consumption of the RFIC. In addition, as the number of channels increases, so will the size and the power consumption of the FPGA module needed for handling the CPRI interface. There is another problem with the conventional RRH architecture shown in FIG. 2. More specifically, in RRH 200, the integrated RFIC module 206 includes both the ADC/DAC modules and the up-/down-converters, meaning that analog and digital signals run on the same chip. The on/off switching of the ADC/DAC modules often generates noises at the RF components, e.g., the up-/down-converters. Certain designs try to mitigate such a noise problem by separating the ADC/DAC modules and the up-/down-converters to make ADC/DAC standalone components. However, such arrangements often result in increased device size, without addressing the power consumption issue.

To overcome the noise problem, in some embodiments of the present invention, the ADC/DAC modules are placed on a separate chip away from other RF components. To ensure a smaller footprint, instead of being standalone components, the ADC/DAC modules are integrated with a CPRI interface to form a system on a chip (SoC) module. Moreover, multiple RF front-end components are packaged together into a system in a package (SiP) module, thus further reducing the overall size of the RRH.

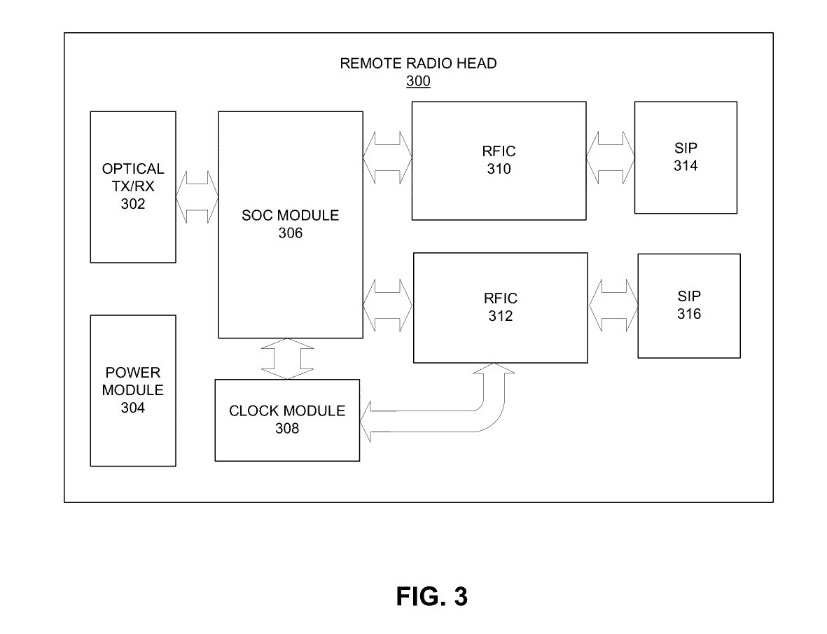

FIG. 3 presents a diagram illustrating the exemplary architecture of a multi-stream RRH, in accordance with an embodiment of the present invention. In FIG. 3, a multi-stream RRH 300 includes an optical transceiver module 302, a power module 304, an SoC module 306, a clock module 308, a number of RFIC modules (such as RFIC modules 310 and 312), and a number of SiP modules (such as SiP modules 314 and 316). In some embodiments, the various components of multi-stream RRH 300 can be mounted onto a single printed circuit board (PCB).

Optical transceiver module 302 provides the optical interface between RRH 300 and the base station. More specifically, optical transceiver module 302 couples to the base station via optical fibers to facilitate the exchange of data and control signals between RRH 300 and the base station. To enable multiple data streams in each direction, various multiplexing technologies, such as time-division multiplexing (TDM), can be used. In some embodiments, optical transceiver module 302 may provide up to eight data channels in each direction. Power module 304 includes the circuitry for the control and management of power. More specifically, power module 304 is responsible for providing power to other modules/components in RRH 300, such as SoC module 306 and RFIC module 310.

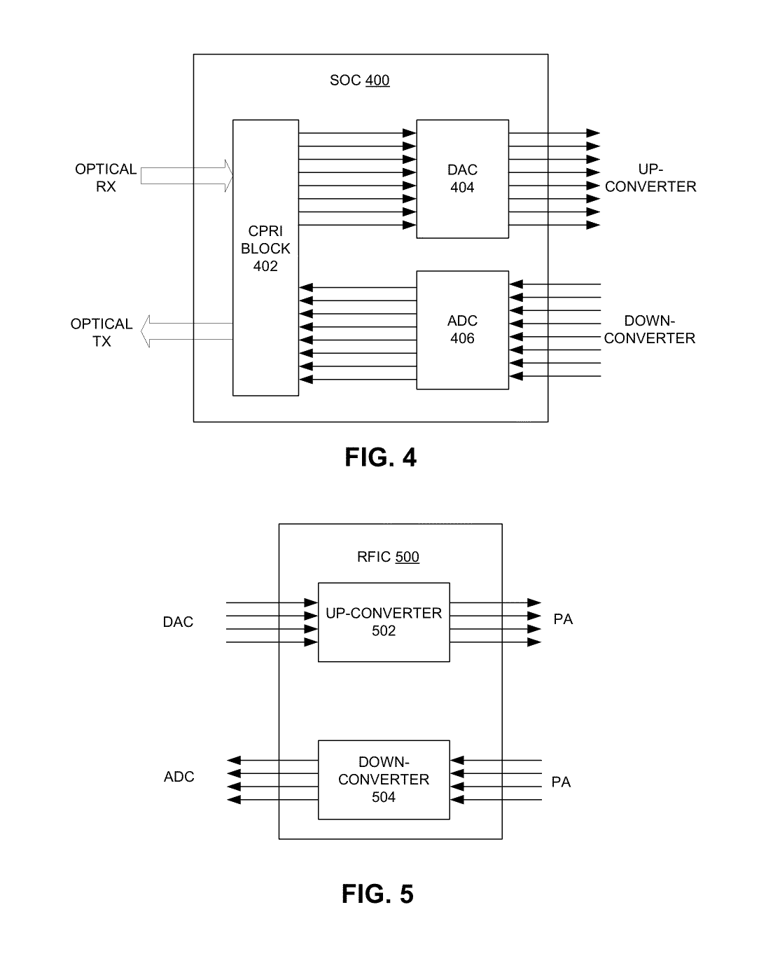

SoC module 306 is an integrated circuit (IC) chip that integrates multiple components (which can include both digital and analog components) onto a single chip substrate. In some embodiments, SoC module 306 includes a processor unit that handles the interface between the base station and RRH 300. In further embodiments, such an interface can be a CPRI interface or an Open Base Station Architecture Initiative (OBSAI) interface. FIG. 4 presents a diagram illustrating the exemplary architecture of an SoC module implemented in a multi-stream RRH, in accordance with an embodiment of the present invention. In FIG. 4, SoC module 400 includes multiple functional blocks, such as a CPRI block 402, a DAC block 404, and an ADC block 406. CPRI block 402 handles the CPRI interface to the base station (via the optical transceiver). More specifically, CPRI block 402 facilitates the exchange of user data, control and management signals, and synchronization signals between the base station and the RRH. According to the CPRI standard, the user data is transformed in the form of quadrature-modulated data (IQ data), and several IQ data flows can be sent via one physical CPRI link. Note that each IQ data flow reflects the data of one antenna for one carrier. Hence, multiple IQ data flows can reflect data to multiple antennas or data for multiple carriers.

In the example shown in FIG. 4, CPRI block 402 is capable of handling up to eight IQ data flows in each direction. More specifically, in the transmitting direction (TX), CPRI block 402 receives time-domain multiplexed data flows from the base station via the optical receiver, de-multiplexes the data flows, and then processes each individual data flow. Note that the multiple data flows can include MIMO data to different antennas, data from different service providers, and data from the same provider but which is to be modulated to different RF frequency bands. After processing, the multiple data flows are sent to multi-channel DAC 404 for digital to analog conversion. For an IQ data flow entering CPRI block 402 with separate I and Q data, each IQ data flow will need two DAC channels. For an IQ data flow entering CPRI block 402 with combined I and Q data (e.g., the I and Q data have been digitally up-converted to an intermediate frequency (IF) and then combined), only one DAC channel is needed to convert the combined IQ data to an analog signal at IF. In FIG. 4, each arrow represents an IQ data flow. The outputs of DAC 404, which include the multiple IQ flows in analog forms, are then sent to the up-converters to be converted to RF signals.

In the receiving (RX) direction, multi-channel ADC 406 receives multiple streams of down-converted RF signals, and converts them to digital data streams. For quadrature-modulated RF signals that have been directly converted to baseband, two ADC channels are needed to generate the separate I and Q data. The outputs of ADC 406, which include multiple data streams, are then sent to CPRI block 402. In FIG. 4, each arrow out of ADC block 406 represents an IQ data flow, which includes separated I channel data and Q channel data. CPRI block 402 then frames the received IQ data flows (which can involve placing appropriate frame headers), time-domain multiplexes the multiple IQ flows to a single data stream, and then sends the multiplexed data to the base station via the optical transmitter.

Now return to FIG. 3, which shows SoC module 306 coupled to RFIC chip 310 and RFIC chip 312. In this example, each RFIC has half the channel capacity of SoC module 306. For example, if SoC module 306 has an 8-channel capacity (able to accommodate up to eight data streams in each direction), then each RFIC only needs to handle four data streams in each direction (TX and RX). This makes it easier for the RFIC to meet the wide-band requirement.

FIG. 5 presents a diagram illustrating the exemplary architecture of an RFIC module, in accordance with an embodiment of the present invention. In FIG. 5, RFIC 500 includes an up-converter block 502 and a down-converter block 504. Up-converter block 502 receives outputs from the DAC module, up-converts the received analog signals to the RF domain, and then sends the RF signals to power amplifiers and antennas for transmission. For the direct-conversion scheme, up-converter block 502 may include a quadrature modulator that uses the I and Q baseband signals as input to generate IQ-modulated RF signals. In the example shown in FIG. 5, up-converter block 502 is capable of up-converting up to four channels of signals. In some embodiments, up-converter block 502 can include a number of mixers and phase shifters. The local oscillators (LOs) needed for the up-conversion can be off-chip, such as being part of clock module 308. In some embodiments, the LOs may be integrated into the RFIC.

On the other hand, down-converter block 504 receives amplified RF signals, down-converts the RF signals to baseband or IF, and then sends the baseband or IF signals to the ADC module for analog-to-digital (AD) conversion. For the direct-conversion scheme, down-converter block 504 may include a quadrature demodulator that demodulates the received RF signals to I and Q baseband signals. In the example shown in FIG. 5, down-converter block 504 is capable of down-converting up to four channels of signals. Similarly to up-converter block 502, down-converter block 504 may include a number of mixers and phase shifters. LOs that are needed for the down-conversion may be located off-chip, such as being located within clock module 308. In some embodiments, the LOs may be located off-chip or integrated as part of the RFIC.

Now return to FIG. 3, which shows each RFIC coupled to an SiP module. For example, RFIC 310 couples to SiP module 314, and RFIC 312 couples to SiP module 316. Each SiP module includes a number of RF front-end components, such as filters, amplifiers, switches, etc., that are needed for the transmission and receiving of the RF signals. In some embodiments, the number of RF front-end components included in the SiP module matches the RF channels on the corresponding RFIC. For example, if the RFIC can accommodate four signal channels, the corresponding SiP may include at least four power amplifiers (PAs) for amplification of the to-be-transmitted RF signals, and at least four low-noise amplifiers (LNAs) for amplification of received signals. By packaging multiple RF front-end components into an SiP module, embodiments of the present invention reduce the footprints of these front-end components, thus ensuring the compactness of the entire RRH module.

### Low-IF RF Architecture

Most RFICs that are used in wireless communication systems adopt the direct-conversion schemes, in which the received RF signals are directly converted to baseband analog I and Q signals that are subsequently converted to digital data. Although providing certain advantages, the direct-conversion RFIC, when used in an RRH, has a number of shortcomings. First, if the modulation scheme is direct conversion, the multi-stream RRH will need more ADC/DAC channels (twice the number of the RRH channel count) for AD/DA conversion. In the RX direction, when the direct-conversion demodulator converts the quadrature-modulated RF signals to baseband, it generates separate I and Q signals, which need two separate ADC channels to convert them to the I and Q data. Similarly, in the TX direction, the direct-conversion modulator needs separate I and Q baseband signals as inputs in order to generate quadrature-modulated RF signals, thus requiring two separated DAC channels to convert the I and Q data to baseband signals. More ADC/DAC channels not only lead to larger module size, but also consume more power. Second, conventional direct-conversion IQ modulator/demodulators are more prone to errors associated with DC offsets, carrier leakage, and IQ imbalance. More specifically, conventional direct-conversion demodulators work by evenly splitting received RF signals and separately mixing them with two LO signals that have a 90° phase shift. The parallel nature of the I/Q demodulator requires that the two legs (I and Q channels) be closely matched to each other and that the quadrature phase shift must be exactly 90° at all frequencies. Hence, the separate I and Q paths can lead to gain and phase imbalance between the I and Q signals, which can further lead to detection errors. Moreover, direct-conversion receivers also face the problem of their inability to reject DC offset and flicker noise. On the other hand, carrier leakage can be a problem in the TX direction.

To mitigate the problems associated with DC offset, carrier leakage, and phase imbalance, many circuit designers include in their design calibration circuits for cancellation of DC-offset, carrier leakage, and IQ imbalance. However, such remedies not only increase the complexity of the RRH module, but also increase maintenance costs, as the RRH may need to be recalibrated based on changes in the environment.

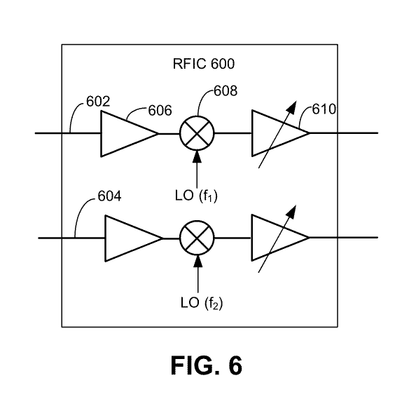

In some embodiments of the present invention, to overcome the deficiencies of the direct-conversion modulation/demodulation scheme, the multi-stream RRH uses a low-IF modulating/demodulating scheme, which moves the spectrum of the to-be-modulated or demodulated signals away from DC. More specifically, the architecture of the RFIC within the RRH is designed to be low IF. FIG. 6 presents a diagram illustrating an exemplary architecture of a low-IF RFIC, in accordance with an embodiment of the present invention. In the example shown in FIG. 6, RFIC 600 includes two receiving paths: receiving path 602 and receiving path 604. Each receiving path includes a mixer for down-converting the RF signals to low IF and one or more amplifiers. For example, receiving path 602 includes a mixer 606, an LNA 608, and a variable gain amplifier (VGA) 610. Note that the mixers, such as mixer 606, are coupled to local oscillators, which can be located off-chip. In some embodiments, the two receiving paths include a main path and a diversity path, meaning the two paths may receive RF signals from two distinct antennas. The LO frequencies for the two receiving paths are different to ensure that the IFs of the two paths are different. However, the LO frequencies vary with the carrier frequency of the selected channel to ensure that the IF for each path is fixed.

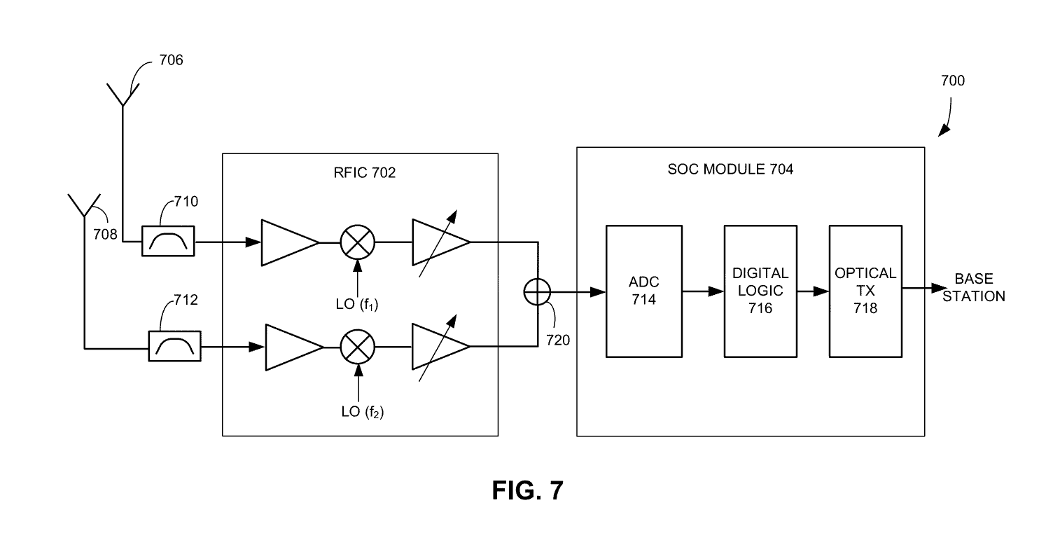

FIG. 7 presents a diagram illustrating the exemplary architecture of the RRH in the RX direction, in accordance with an embodiment of the present invention. In FIG. 7, RRH 700 includes an RFIC 702 and SoC module 704. RFIC 702 has been described in connection with FIG. 6. SoC module 704 includes an ADC 714, a digital logic block 716, and an optical transmitter 718. The two receiving paths of RFIC 702 are coupled to antennas 706 and 708 via band pass filters (BPFs) 710 and 712, respectively. Note that, as described previously, each of the two receiving paths in RFIC 702 down-converts the received RF signals to a different IF.

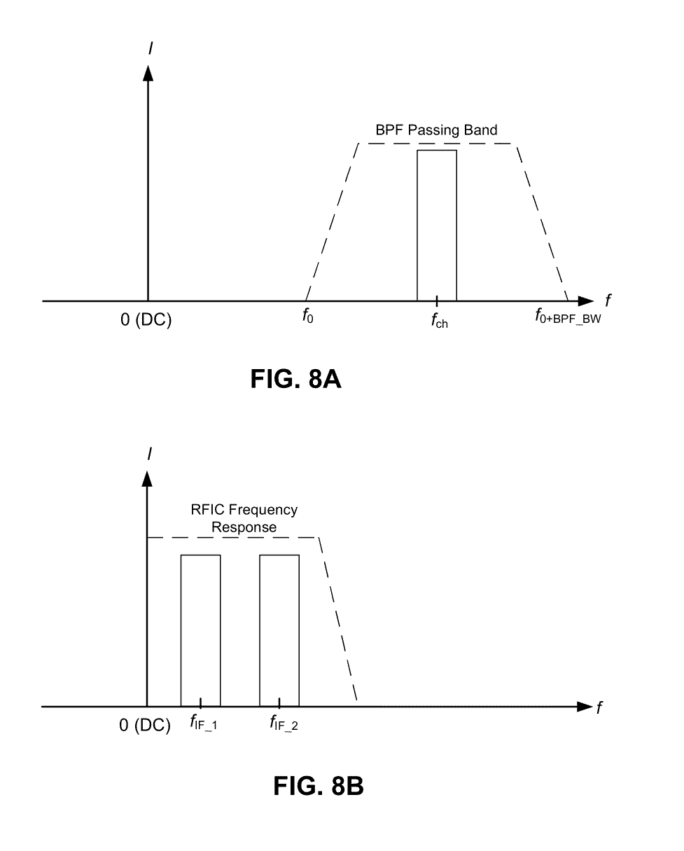

In cases where the second receiving path is a diversity path, the spectrum of the RF signals input into each receiving path is the same, as shown in FIG. 8A. On the other hand, if the second receiving path is for a different frequency band (such as for signals from a different provider), the spectrum of the input of the two receiving paths may be different. In FIG. 8A, the center frequency of the received RF signal is denoted as f_{ch}. In addition to the spectrum of the RF signals, FIG. 8A also illustrates the passing band of the band-selection BPF, such as BPF 710 (indicated by the dashed line), with the lower edge of the passing band denoted as f₀ and the upper edge of the passing band denoted as f_{0+BPF}_{_{—}}_{BW} (BPF_BW stands for the bandwidth of the BPF).

To prevent interference between the two receiving paths, the two IFs are carefully selected to ensure that the two IF signals do not overlap in the frequency domain, as shown in FIG. 8B. This can be achieved by making sure the difference between the two IFs is greater than the signal bandwidth. In FIG. 8B, the center frequencies of the IF signals at the outputs of two receiving paths are denoted as f_{IF}_{_{—}}₁ and f_{IF}_{_{—}}₂. Note that such center frequencies are fixed regardless of the RF carrier frequency f_{ch}. More specifically, it is the LO frequency of each receiving path that is adjusted based on f_{ch}. For example, the LO frequency for the first receiving path can be set as f_{LO}_{_{—}}₁=f_{ch}−f_{IF}_{_{—}}₁, and the LO frequency for the second receiving path can be set as f_{LO}_{_{—}}₂=f_{ch}−f_{IF}_{_{—}}₂. Also note that f_{IF}_{_{—}}₁ needs to be sufficiently away from DC to ensure that the IF signal does not have a DC component. In some embodiments, f_{IF}_{_{—}}₁ is somewhere between 30 and 40 MHz. In addition to the IF spectra, FIG. 8B also illustrates the frequency response of the RFIC (indicated by the dashed line), which reflects the bandwidth of the VGCs. From FIG. 8B, one can see that the bandwidth of the VGCs on the RFIC needs to be wide enough to accommodate IF bands of both paths. In some embodiments, the gain bandwidth of the RFIC is at least 40 MHz, given that the bandwidth of the RF signal is between 10 and 20 MHz. Note that conventional RFICs tend to require a smaller gain bandwidth because direct-converted signals are symmetric around DC and hence have a narrower bandwidth.

In some embodiments, the two IF signals are combined by an adder (which can also be a multiplexer) 720 before being sent to ADC 714 for AD conversion, as shown in FIG. 7. Note that the sampling rate of ADC 714 needs to be high enough to prevent alias. The output of ADC 714 is sent to digital logic block 716, which is responsible for quadrature demodulation (performed in the digital domain) and encapsulating appropriate frame headers (such as CPRI headers) onto the demodulated data. Such data streams that are in appropriate frame format are then multiplexed in the time domain and sent to the base station via optical transmitter 718. Note that in the example shown in FIG. 7, instead of sending complex signals (at baseband) that include I and Q components, RFIC module 702 sends, to ADC 714 located on SoC module 704, real signals (at IF), which need only one ADC channel for AD conversion. Also note that the bandwidth of the single sideband of the real signals will be much wider, often more than twice as wide, than the bandwidth of the baseband signals; hence, the gain spectrum of RFIC 702 and the sampling rate of ADC 712 need to be increased accordingly.

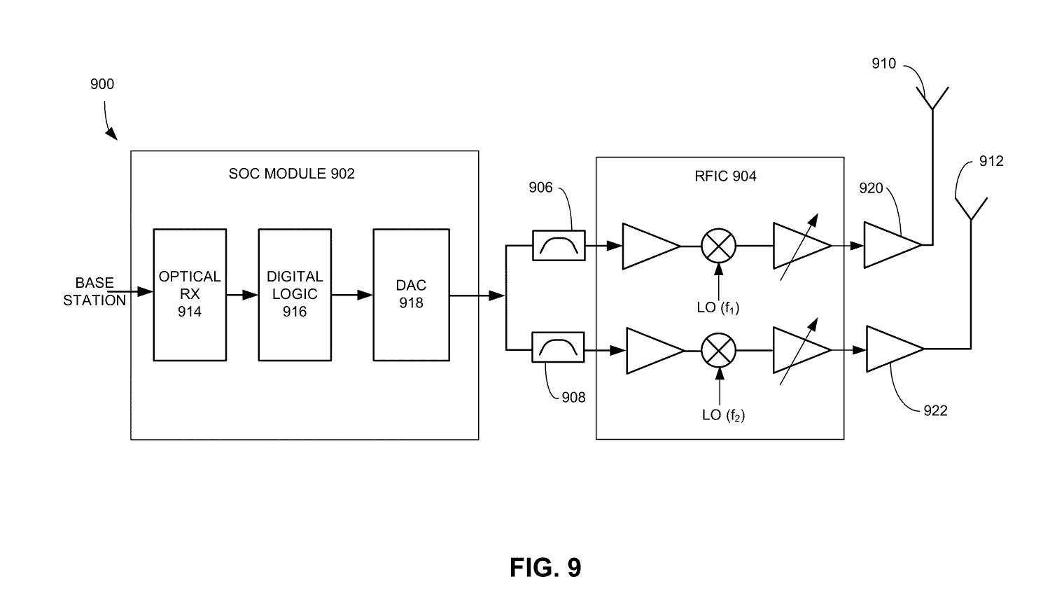

FIG. 9 presents a diagram illustrating the exemplary architecture of the RRH in the TX direction, in accordance with an embodiment of the present invention. In FIG, 9, RRH 900 includes an SoC module 902 and an RFIC 904 (which is similar to the one shown in FIG. 6). SoC module 902 includes an optical receiver 914, a digital logic block 916, and a DAC 918. RFIC 904 includes two transmission paths that are coupled to DAC 918 via band-selection BPFs 906 and 908. Outputs of the two transmission paths of RFIC 904 are coupled to antennas 910 and 912 via PAs 920 and 922, respectively. Note that, similar to the RFIC shown in FIG. 6, each of the two transmitting paths in RFIC 902 up-converts the IF signals to the RF domain.

During operation, optical receiver 914 receives to-be-transmitted data, often time-multiplexed and in IQ format, from the base station. The received data is sent to digital logic block 916, which is responsible for de-multiplexing and extracting user data. In some embodiments, digital logic block 916 removes the CPRI frame headers. According to the CPRI standard, data received from the baseband includes I and Q data. In some embodiments, digital logic block 916 includes a digital quadrature modulator which modulates and digitally up-converts the baseband data to IF data. At IF, instead of having separate I and Q data, the IF data is a single data stream, which is then sent to DAC 918 for DA conversion. The output of DAC 918 is an analog signal at IF.

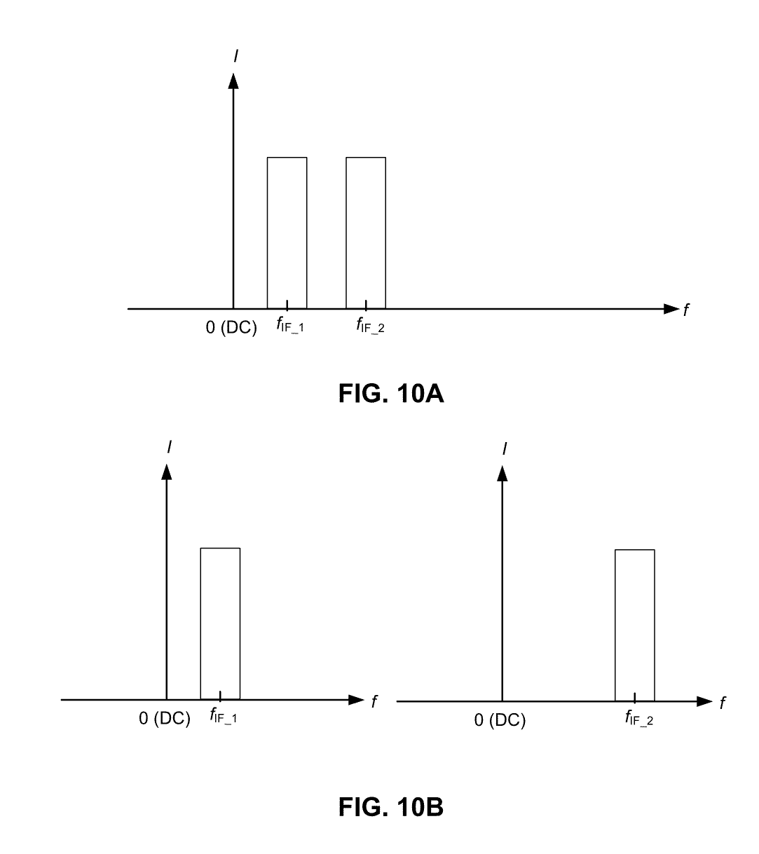

FIG. 10A presents a diagram illustrating the spectrum of the signal at the DAC output, in accordance with an embodiment of the present invention. In FIG. 10A, the output of DAC 918 includes two spectrally separated IF signals with center frequencies denoted as f_{IF}_{_{—}}₁ and f_{IF}_{_{—}}₂. Note that the two IF frequencies are carefully selected to ensure that these two IF signals do not overlap in the frequency domain. Looking back at FIG. 9, the output of DAC 918 is sent to RFIC 904 via BPFs 906 and 908. Note that each of the two BPFs selects an IF signal for its corresponding transmission path. FIG. 10B presents a diagram illustrating the spectrum of the signal at the output of each BPF, in accordance with an embodiment of the present invention. From FIG. 10B, one can see that one BPF selects an IF signal with center frequency f_{IF}_{_{—}}₁, shown by the left drawing; and the other BPF selects an IF signal with center frequency f_{IF}_{_{—}}₂, shown by the right drawing. Each IF signal is amplified and up-converted to the RF domain by each transmission path. Note that the LO frequency of each transmission path is determined by the IF and the targeted RF carrier frequency.

For example, if the targeted RF carrier has a frequency of f_{ch}, then the LOs are set as f_{LO}_{_{—}}₁=f_{ch}−f_{IF}_{_{—}}₁ and f_{LO}_{_{—2}}=f_{ch}−f_{IF}_{_{—}}₂. Note that it is possible that the two transmitted RF signals have different carrier frequencies.

In general, compared with traditional direct-conversion RFIC architecture, which often has a narrower bandwidth and includes separate I and Q paths, in embodiments of the present invention, the RFIC that is implemented in the RRH has a low-IF architecture. More specifically, the RFIC down-converts RF signals to IF and up-converts IF signals to RF, and the signals exchanged between the RFIC and ADC/DAC module are real. Such real signals require only one ADC/DAC channel for AD/DA conversion of an RRH channel, thus significantly reducing both size and power consumption of a multi-stream RRH. Moreover, by combining the IQ path and by moving the signal spectrum away from DC, embodiments of the present invention relax the calibration requirement associated with DC offset, carrier leakage, and IQ imbalance, thus lowering the maintenance costs.

Note that the architecture shown in FIGS. 6-7 and 9 is merely exemplary and should not limit the scope of this disclosure. For example, in FIG. 6, RFIC 600 includes two paths. In practice, RFIC 600 may include more or fewer paths.

In addition, FIG. 8A shows that the two paths have the same RF carrier frequency. In practice, depending on the need and the implication, the various paths in the RX or TX direction may have the same or different carrier frequencies. For example, if the RRH is intended to provide multiple services, the various paths may have different RF frequencies.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A remote radio head (RRH) for a wireless communication system, comprising:
a first integrated circuit (IC) chip that comprises multiple functional blocks, wherein the multiple functional blocks include at least a processing unit, a digital-to-analog converter (DAC), and an analog-to-digital converter (ADC); and
a second IC chip that comprises at least an up-converter and a down-converter, wherein the up-converter is configured to convert an intermediate frequency (IF) signal received from the first IC chip to radio frequency (RF) domain, and wherein the down-converter is configured to convert an RF signal received from an antenna to an IF signal to be sent to the first IC chip.

2. The RRH of claim 1, further comprising a plurality of RF front-end components that are packaged into a system in package (SiP) module.

3. The RRH of claim 1, wherein the processing unit is configured to facilitate a communication interface between a base station and the RRH, and wherein the communication interface includes one of:
a common public radio interface (CPRI); and
an open base station architecture initiative (OBSAI) interface.

4. The RRH of claim 1, wherein the processing unit is configured to:
receive an in-phase (I) baseband data stream and a corresponding quadrature (Q) baseband data stream from a base station; and
digitally modulate the I baseband data stream and the Q baseband data stream to a real IF data stream, thereby allowing the real IF data stream to be converted to analog domain using a single DAC channel.

5. The RRH of claim 4, wherein the second IC chip further comprises one or more amplifiers, and wherein the amplifiers have a gain bandwidth that is at least twice the baseband data streams' bandwidth.

6. The RRH of claim 5, wherein the gain bandwidth is at least 40 MHz.

7. The RRH of claim 1, wherein the ADC is configured to convert the down-converted IF signal to a digital IF signal using a single channel, and wherein the processing unit is configured to demodulate the digital IF signal to an in-phase (I) data stream and a quadrature data stream.

8. A method for transmitting data for wireless communication using a remote radio head (RRH), the method comprising:
receiving, by the RRH from a base station, baseband data that includes an in-phase data stream and a quadrature (Q) data stream;
digitally modulating the I data stream and the Q data stream into a real intermediate frequency (IF) data stream;
converting the real IF data stream to an analog IF signal;
frequency up-converting the analog IF signal to an analog RF signal; and
transmitting the converted RF signal.

9. The method of claim 8, wherein converting the real IF data stream to an analog IF signal involves a single digital-to-analog converter (DAC) channel.

10. The method of claim 8, further comprising amplifying the analog IF signal, wherein amplifying the analog IF signal involves an amplifier with a gain bandwidth that is at least twice the baseband data's bandwidth.

11. The method of claim 10, wherein the gain bandwidth is at least 40 MHz.

12. The method of claim 8, wherein receiving the baseband data from the base station involves a common public radio interface (CPRI) or an open base station architecture initiative (OBSAI) interface.

13. A method for receiving data for wireless communication using a remote radio head (RRH), the method comprising:
receiving, by the RRH from an antenna, a radio frequency (RF) signal;
frequency down-converting the RF signal to an intermediate frequency (IF) signal;
converting the IF signal to a digital IF data stream;
digitally demodulating the IF data stream to an in-phase (I) baseband data stream and a quadrature (Q) baseband data stream; and
sending the I and Q baseband data streams to a base station.

14. The method of claim 13, wherein converting the IF signal to a digital IF data stream involves a single analog-to-digital converter (ADC) channel.

15. The method of claim 13, further comprising amplifying the down-converted IF signal, wherein amplifying the down-converted IF signal involves an amplifier with a gain bandwidth that is at least twice the baseband data streams' bandwidth.

16. The method of claim 15, wherein the gain bandwidth is at least 40 MHz.

17. The method of claim 13, wherein sending the baseband data streams to the base station involves a common public radio interface (CPRI) or an open base station architecture initiative (OBSAI) interface.

18. A radio frequency integrated circuit (RFIC) chip implemented in a remote radio head (RRH), wherein the RFIC chip is configured to communicate with a base station via a second IC chip, the RFIC chip comprising:
at least an up-converter and a down-converter, wherein the up-converter is configured to convert an intermediate frequency (IF) signal received from the second IC chip to radio frequency (RF) domain, and wherein the down-converter is configured to convert an RF signal received from an antenna to an IF signal to be sent to the second IC chip.

19. The RFIC chip of claim 18, further comprising one or more amplifiers, wherein the amplifiers have a gain bandwidth that is at least twice the baseband data streams' bandwidth.

20. The RFIC chip of claim 19, wherein the gain bandwidth is at least 40 MHz.

21. The RFIC chip of claim 18, further comprising multiple signal paths to allow multiple IF signals to be up-converted to RF domain and multiple RF signals to be down-converted to IF domain simultaneously.
